(19) United States
(12) Patent Application Publication
(10) Pub. No.: US 2008/0317940 A1
(43) Pub. Date: Dec. 25, 2008

(54) Method for Producing Corrugated Cardboard

(76) Inventor: Herbert B. Kohler, Uniontown, OH (US)

Correspondence Address: PEARNE & GORDON LLP, 1801 EAST 9TH STREET, SUITE 1200, CLEVELAND, OH, 44114-3108, US

(21) Appl. No.: 12/142,507

(22) Filed: Jun. 19, 2008

Related U.S. Application Data
(60) Provisional application No. 60/936,411, filed on Jun. 20, 2007.

(51) Int. Cl. B05D 1/28

(52) U.S. Cl. 427/8

(57) ABSTRACT

A method of applying adhesive to flutes of a corrugated sheet includes the steps of applying a layer of adhesive on an outer surface of an applicator roll, rotating the applicator roll, and rotating a web positioning roll adjacent the applicator roll. The web positioning roll and the applicator roll each have rotational axes and define a gap between respective outer surfaces thereof. The corrugated sheet is moved along a path adjacent the outer surface of the applicator roll to apply adhesive to the flutes from the layer of adhesive. A control system is utilized to automatically maintain the rotational axes substantially parallel to one another. In other examples, the control system can automatically maintain a desired width of the gap, maintain a desired pressure to be applied to the flute crests, and/or automatically determine flute height.

### CROSS-REFERENCE TO RELATED APPLICATIONS

This application claims the benefit of U.S. Provisional Application No. 60/936,411, filed Jun. 20, 2007, the entire disclosure of which is hereby incorporated herein by reference.

### FIELD OF THE INVENTION

The present invention relates generally to the production of corrugated cardboard, and more particularly, to a novel and improved method for accurately controlling the application of an adhesive to the flutes of corrugated board centered on the flute crests, so that the flutes can be bonded to a face.

### BACKGROUND OF THE INVENTION

Corrugated cardboard composite is used in a large number of applications. It is particularly desirable in packaging applications because it is rugged and has high dimensional and structural integrity.

Typically, corrugated cardboard is formed by producing a corrugated sheet which is initially bonded along one side to a single face. Adhesive is then applied to the crests of the flutes remote from the single face by an applicator roll of a glue machine. Thereafter, a second face is applied to the adhesive on the flutes to produce a composite structure in which corrugations extend between and are bonded to spaced-apart faces.

In some instances, multiple-layer cardboard is produced in which more than one corrugated sheet is adhesively attached to additional faces so that, for example, a central flat face is bonded to a corrugated sheet on each side thereof, and outer flat faces are bonded to the sides of the two corrugated sheets remote from the central face.

The corrugated sheet is typically passed between a web positioning roll and an applicator roll to apply the adhesive to the flutes. The web positioning roll typically applies sufficient downward pressure to force the flute tips into contact with the applicator roll. This downward pressure causes compression or deformation of the flutes. The flutes enter the adhesive layer prior to being crushed against the applicator and often become overly wetted or saturated with adhesive due to the long dwell time. As a result, the flutes do not return to their original shape after being crushed. This permanent deformation of the flutes reduces the strength of the final cardboard.

To carry out this method, a conventional corrugator glue machine has been used for applying glue to exposed flute crests opposite the first-face sheet. However, the adhesive applied to the flutes can be asymmetrical because the flutes plow through the adhesive layer on the applicator and are wetted on one sloped face more than the other. This asymmetrical application of the adhesive results in a lower bond strength for a given weight of adhesive and a rough surface finish on the face sheet due to warpage after the adhesive cures. Additionally, a relatively large amount of over spray is created which further increases the amount of glue used by the process. In one solution, the glue film can be applied to the outer surface of the applicator as described in U.S. Pat. No. 6,602,546, which is incorporated herein by reference.

Still, there is a need in the art for an improved method for producing corrugated cardboard which obtains maximum strength in the finished product and an improved surface finish on the face. Furthermore, it can be desirable to apply substantially less adhesive per unit area of the finished product and to produce the improved cardboard at an increased rate of production. It is particularly desirable to provide a method of applying adhesive accurately and sparingly to the centers or crests of the corrugated flutes without significant adhesive being applied to either the leading or trailing sloped faces of the flutes. Most preferably, such a method may employ a control system programmed to automatically adjust any or all of a pressure loading force to be applied to the corrugated flutes of various flute sizes, a gap width between the rollers, relative alignment of the rollers (i.e., parallelism), and/or even automatically detect flute height.

### BRIEF SUMMARY OF THE INVENTION

The present invention provides a method and apparatus for uniformly and accurately applying adhesive to the crests of the flutes of corrugated sheets with little or no (or substantially no) adhesive being applied to either the leading or trailing sloped faces of the flutes. In accordance with the present invention, higher line speeds can be achieved, tighter performance specifications exceeding the capability of the industries standard machines are possible, and a significant reduction in the amount of glue used is achieved. In addition, accurately centering the adhesive onto the crests of the flutes provides stronger bond strength between the corrugated sheet and the adhered-to face sheet. Directional differences in strength are minimized or substantially eliminated, and surface smoothness of the face sheets is improved (washboarding reduced). Because the adhesive is very accurately deposited only to the flute crests, it is possible to reduce the adhesive weight deposition rate about 10-70%, or even more, of that required in conventional machines while delivering the same or comparable bond and crush strength. Additionally, because there is no practical lower limit to the controlled glue weight, cold set adhesives can be used to further improve board properties and reduce energy costs and warpage losses. Furthermore, in accordance with the present invention, smoother and more printable boards with greatly reduced warpage and improved surface finish are produced.

To achieve still further aspects and in accordance with the present invention, a method of applying adhesive to flutes of a corrugated sheet, where each the flute has a crest, is provided. The method includes the steps of applying a layer of adhesive on an outer surface of an applicator roll and rotating the applicator roll, and rotating a web positioning roll adjacent said applicator roll. The web positioning roll and said applicator roll each have a rotational axis and define a gap between respective outer surfaces thereof. The corrugated sheet is moved, via rotation of the web positioning roll, along a path adjacent the outer surface of the applicator roll to apply adhesive to the flutes from the layer of adhesive, and the path of the corrugated sheet proceeds through the gap. A control system is utilized to automatically maintain each of the rotational axes substantially parallel to one another based upon a comparison of a plurality of measurements of the width of the gap, and the crest of the flute is contacted with the applicator roll thereby depositing glue on the crest.

To achieve still further aspects and in accordance with the present invention, a method of applying adhesive to flutes of a corrugated sheet, where each the flute has a crest, is provided. The method includes the steps of applying a layer of adhesive on an outer surface of an applicator roll and rotating the applicator roll, and rotating a web positioning roll adjacent said applicator roll. The web positioning roll and said applicator roll define a gap between respective outer surfaces thereof. The corrugated sheet is moved, via rotation of the web positioning roll, along a path adjacent the outer surface of the applicator roll to apply adhesive to the flutes from the layer of adhesive, and the path of the corrugated sheet proceeds through the gap. An average height of a plurality of the flute crests is measured, and a desired width of the gap is determined based upon the average height. A control system is utilized to automatically adjust the position of the web positioning roll relative to the applicator roll to maintain the desired width of the gap, and the crest of the flute is contacted with the applicator roll thereby depositing glue on the crest.

To achieve still further aspects and in accordance with the present invention, a method of applying adhesive to flutes of a corrugated sheet, where each the flute has a crest, is provided. The method includes the steps of applying a layer of adhesive on an outer surface of an applicator roll and rotating the applicator roll, and rotating a web positioning roll adjacent said applicator roll. The web positioning roll and said applicator roll define a gap between respective outer surfaces thereof. The corrugated sheet is moved, via rotation of the web positioning roll, along a path adjacent the outer surface of the applicator roll to apply adhesive to the flutes from the layer of adhesive, and the path of the corrugated sheet proceeds through the gap. An average height of a plurality of the flute crests is measured, and a desired pressure to be applied to the flute crests passing through the gap is determined based upon the average height. A control system is utilized to automatically adjust the position of the web positioning roll relative to the applicator roll to maintain the desired pressure, and the crest of the flute is contacted with the applicator roll thereby depositing glue on the crest.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 shows a side view of a corrugator glue machine according to an aspect of the invention;

FIG. 2 shows a top perspective view of the corrugator glue machine of FIG. 1;

FIG. 3 is an enlarged fragmentary view, partially in cross-section, showing a portion of the glue mechanism of FIG. 1 at an interface between an applicator roll and a web positioning roll;

FIG. 4 is an enlarged view as in FIG. 3, showing glue being applied to the flute crests of a corrugated sheet along a path between the applicator roll and the web positioning roll according to another aspect of the invention;

FIG. 5 is a schematic view of an example drive system for driving the applicator roll and for controlling the speed thereof;

FIG. 6 is an enlarged elevation view of a single face corrugated sheet of with adhesive applied to the crests of the flutes;

FIG. 7A is a top view showing parallel alignment between an applicator roll and a web positioning roll;

FIG. 7B is similar to FIG. 7A, but shows a skewed alignment between the applicator roll and the web positioning roll;

FIG. 8A is a flow-chart showing an example control algorithm for use with a control system in accordance with another aspect of the present invention;

FIG. 8B is a continuation of the flow-chart of FIG. 8A;

FIG. 9 is a schematic view of an example non-contact automatic flute height measurement system in accordance with another aspect of the invention; and

FIG. 10. is a schematic view of an example contact automatic flute height measurement system in accordance with another aspect of the invention.

### DESCRIPTION OF EXAMPLE EMBODIMENTS

Example embodiments that incorporate one or more aspects of the present invention are described an illustrated in the drawings. These illustrated examples are not intended to be a limitation on the present invention. For example, one or more aspects of the present invention can be utilized in other embodiments and even other types of devices.

As used herein, the terms ‘glue’ and ‘adhesive’ are used interchangeably, and refer to the adhesive that is applied to the flute crests of a corrugated sheet according to the invention as hereinafter described. Also as used herein, the term ‘web’ refers to the corrugated sheet traveling through a glue machine 10, and particularly as it travels past an applicator roll for applying adhesive thereto as will be further described. In the description that follows, and from the drawings, it will be apparent that the web speed can be controlled, at least in part, by the rotational speed of the web positioning roll.

Herein, all machine elements or members, such as support arms 20a and 20b, cross member 25, etc., are considered to be rigid, substantially inelastic elements or members under the forces encountered by them in the described corrugator glue machine 10. All such elements or members can be made using conventional materials in a conventional manner as will be apparent to persons of ordinary skill in the art based on the present disclosure.

A corrugator glue machine 10 for use with the present invention is provided having an idler roller and a web positioning roller that cooperate to at least partially define a serpentine web path through the machine. A position of the positioning roller is freely adjustable within a predetermined range during operation of the machine.

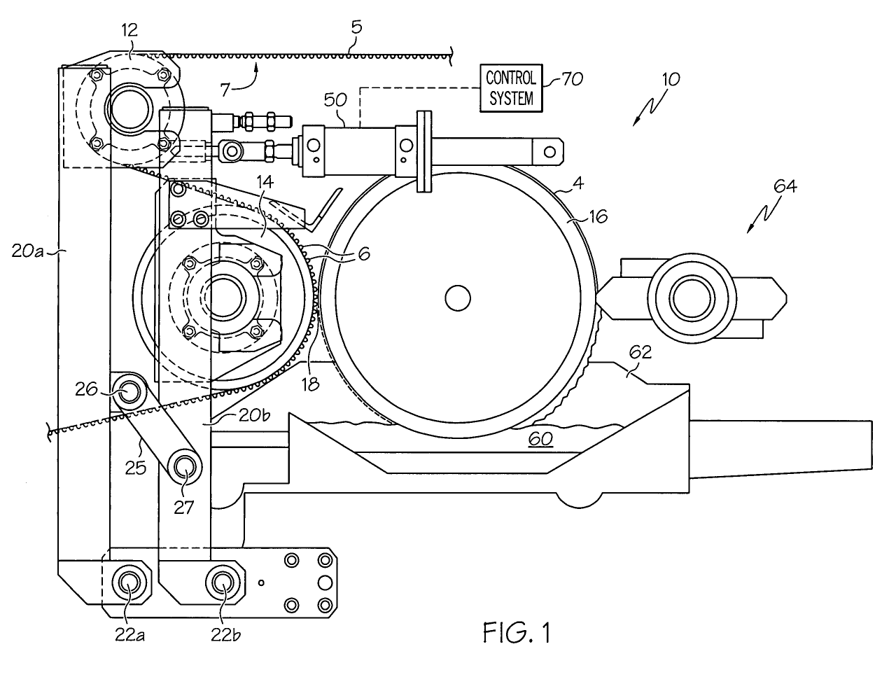

Turning to the shown example of FIG. 1, an example embodiment of a corrugator glue machine 10 is shown, incorporating an example web tension nulling mechanism such as described in U.S. Pat. No. 7,267,153, which is incorporated herein by reference. Although not required for use with the present invention, the web tension nulling mechanism can be effective to cancel out forces exerted on the web positioning roller resulting from tension in the web, such that these forces do not substantially affect the position of the positioning roller within the predetermined range. It is to be understood that while not required, use of such a web tension nulling mechanism as described herein can be beneficial when used in cooperation with the method of the present invention.

The glue machine 10 generally includes a delivery idler roller 12, a web positioning roller 14 and a glue applicator roller 16 substantially similar in placement as the corresponding rollers described above. In operation, the web 5 is conveyed toward and around the delivery idler roller 12, then toward and around the web positioning roller 14 in a generally serpentine path such that, on traversing a gap 18 defined between the rollers 14, 16, the web 5 is oriented having its flutes 7 facing the glue applicator roller 16 and is pressed up against the outer circumferential surface of that roller 16 to achieve the desired level of glue application onto the exposed flute crests 6 of the passing web 5.

The delivery idler roller 12 is rotationally attached to a first support arm 20a whose proximal end is pivotally attached to a base 40 of the glue machine 10 (or to rigidly connected members which together comprise a base for the glue machine) at support pivot joint 22a. The web positioning roller 14 is rotationally attached to a second support arm 20b, whose proximal end is pivotally attached to the base 40 of the glue machine 10 at a second support pivot joint 22b. Each of the support arms 20a and 20b is independently pivotable relative to the base 40 of the glue machine about its own respective support pivot axis defined at its respective pivot joint. In one example embodiment, each of the support pivot joints 22a and 22b can be located or vertically aligned substantially beneath the center of gravity (axis of rotation) of the respective roller 12, 14 during operation of the glue machine, so the roller masses do not induce significant moments about the pivot joints in their respective support arms 20a, 20b which must be compensated for by a control system 70, which may include the actuators 50 (described below). Alternatively, each of the support arms 20a and 20b can be pivotally attached at its proximal end at the same pivot joint (e.g. on the same shaft) or at coaxially aligned pivot joints, so long as the support arms 20a and 20b remain independently pivotable relative to one another (except as a result of the cross member 25, described below).

A cross member 25 is provided extending transversely of, and linking the first and second support arms 20a and 20b as described in this paragraph. The cross member 25 is pivotally attached at its first end to the first support arm 20a at a first linking pivot joint 26, and at its second end to the second support arm 20b at a second linking pivot joint 27. Thus, the cross member 25 is freely pivotable relative to each of the first and second support arms 20a and 20b at the respective linking pivot joint 26, 27, and but for its attachment to the other support arm at its opposite end, the cross member 25 would be free to rotate about each of the linking pivot joints at each support arm. The geometry of the cross member 25 is selected based on the locations of the rotational axes of the idler and positioning rollers 12 and 14 relative to their respective support pivot joints 22a and 22b so that the greater moment generated at the idler roller 12, compared to that generated at the positioning roller 14, from web tension is mechanically balanced out to achieve equilibrium in both support arms based on web tension-induced forces. Thus, as described in U.S. Pat. No. 7,267,153, which is incorporated herein by reference, the web tension nulling mechanism, via the cross member 25, can be effective to cancel out forces exerted on the web positioning roller resulting from tension in the web, such that these forces do not substantially affect the position of the positioning roller within the predetermined range.

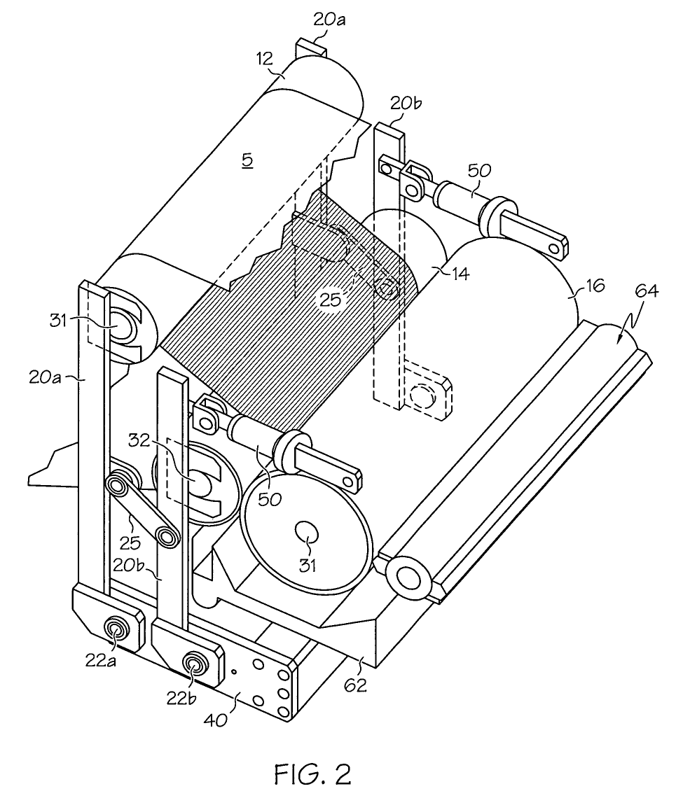

It will be understood that FIG. 1 is a side view, and that typically the glue machine 10 will have two “first” support arms 20a located at opposite ends of the laterally extending delivery idler roller 12, as well as two “second” support arms 20b located at opposite ends of the laterally extending web positioning roller 14 (see FIG. 2). In the illustrated embodiment, each of the rollers 12 and 14 is rotationally supported on a respective axially extending lateral shaft 31,32 that is supported at its opposite ends on the paired “first” support arms 20a or the paired “second” support arms 20b as shown in FIG. 2. In this embodiment, a suitable cross member 25 is provided linking both sets of the adjacent first and second support arms 20a and 20b located on either side of the glue machine 10, with each cross member 25 having suitable geometry as described above to null out web tension effects. Alternatively, the glue machine can be provided such that each of the rollers 12 and 14 is rotationally supported on a shaft that is cantilevered from a single support arm, such as the respective first and second support arms 20a and 20b shown in FIG. 2, located on only one side of the machine. In this case, a cross member 25 is provided on only one side of the machine 10 linking the first and second support arms 20a and 20b.

The present invention has been described as optionally incorporating a web tension nulling mechanism that is provided with respect to a transversely extending cross member 25 pivotally linked to first and second support arms 20a and 20b, which in turn support the idler roller 12 and web positioning roller 14. However, the nulling mechanism is not to be correspondingly limited to this construction. For example, it is possible and contemplated that linkage systems comprising a plurality of members can be incorporated to dynamically link the idler and positioning rollers 12 and 14, or the first and second support arms 20a and 20b, so as to effectively cancel out the web tension-induced forces as described herein; the invention is not limited to a single cross member 25. Also, it will be evident to the person of ordinary skill in the art, on reading the present disclosure, that other mechanical linkages or linkage systems can be established to achieve the web tension nulling effect as described, herein, so that the actuator 50 that is operatively coupled to the positioning roller 14 is shielded from web tension-induced forces during operation of the glue machine 10. It is contemplated that the present invention can include all such mechanical linkages and linkage systems. The constructions disclosed herein are provided to illustrate exemplary embodiments of the invention.

Using such a mechanism, it is possible to provide very precise gap-width control at the nip 18 between the positioning and glue applicator rollers 14 and 16. Consequently, the pressure at which the flutes 7 are compressed against the roller 16 surface (and the corresponding degree of compression of those flutes 7) can also be very precisely controlled. The glue can be provided in various manners. In one example, as described in U.S. Pat. No. 6,602,546, which is incorporated herein by reference, the glue 60 is provided within a glue tray 62 and is picked up through rotation of the applicator roll 16. An isobar assembly 64 is mounted adjacent to the periphery of the applicator roll 16 and removes excess adhesive from the outer peripheral surface of the applicator roll 16 to provide an adhesive coating 4 having precise uniform thickness on the outer peripheral surface of the applicator roll 16 after it has rotated past the isobar assembly 64. The isobar assembly 64 can provide various glue thicknesses, such as at least 0.002, 0.003, 0.004, 0.005, or 0.006, inches, or even 0.0015 inches or less.

Using this mechanism, it has been discovered that ever thinner layers of glue film 4 on the glue applicator roll 16 can be used, and yet the bond between the flute crests and the later-applied liner is actually improved, despite thinner glue film 4 thickness on the applicator roll. This is achieved by no longer relying on glue thickness to obtain sufficient glue penetration and/or coverage on the flute crest to ensure a good bond between the flute and the liner sheet.

Instead, the gap width of the nip 18 is very precisely controlled, taking account of the flute size, to compress the flute tips 6 against the surface of the glue applicator roll 16, with the glue film 4 on its surface. As shown in FIGS. 3-4, the compression of the flute crests 6 creates an essentially flat, conforming surface that conforms to the glue applicator roll 16 surface contour. The rotation of that roller 16 while the flute is compressed against it essentially smears the very thin layer of glue film 4 over the flattened portion of the flute crest 6, actually ‘pressing’ the glue 4 into the porous/fibrous structure of the flute crest 6.

In other words, one function of the starch adhesives in the glue is to “bridge” or fill in the voids between two adherends, such as the flute crests and a face sheet. In one example, a minimum amount of glue can correspond with the size of the hills and valleys on the adherend surfaces and the void space between them. Indeed, the bond strength may increase with a decreasing glue thickness. For example, the Young's modulus of the glue bond can relatively increase with a decreasing film thickness because the glue film becomes generally more resistant to bending as it gets thinner.

Care must be taken to ensure the degree of compression is not sufficient to irreversibly compress the flute 7; the flute 7 must be able to recover or ‘spring back’ to its original uncompressed shape following contact with the glue applicator roller 16. The very thin glue film 4 thickness helps achieve this, by not soaking the flutes 7 with liquid water, which may impede springy recovery of the flutes 7.

In essence, the degree of compression, coupled with the size of the flutes 7, can be used to control the thickness of the glue line applied to each flute crest 6. For example, glue line thickness (width in the longitudinal direction for each flute 7) can be generally equal to the width of the flattened surface (i.e., of the flute crest 6) that is compressed against the glue applicator roller 16.

Using this method, it is possible to very precisely meter a very thin glue line on the flutes 7, with finely tuned glue line thicknesses (widths in longitudinal flute direction) even using positioning and applicator rollers 14 and 16, and associated rotational bearings, having relatively large error tolerances. Because the compression-flat surface now dictates the glue line width, that width can be metered to a very tight tolerance despite relatively large out-of-round tolerances for the circumferential surfaces of rollers 14, 16, or their associated rotational bearings.

As shown in FIG. 3, the position of the web positioning roller 14 is adjustable directly toward and away from the glue applicator roll 16 along the direction of arrow A so that the width of the gap 18 can be precisely adjusted to control the degree to which the flutes 7 of the web 5 are compressed against the glue applicator roll 16 as they pass through gap 18. The degree of flute compression can be controlled to a high degree of accuracy because the web positioning roller 14 is linearly adjustable; that is, the rotational axis 32 of the web positioning roller 14 is movable directly toward and away from the rotational axis 31 of the glue applicator roll 16. In other words, the distance D between the rotational axes 31, 32 can be selectively adjusted. Additionally, flexure of the rolls 14, 16 due to gravity does not affect the gap 18 because the gap 18 is vertical.

The width of the gap 18 is preferably precisely closed and opened by a closed loop control system 70. In one example, the control system 70 can include a motor and a linear transducer which moves the web positioning roller 14 toward and away from the glue applicator roll 16 to adjust the distance therebetween (i.e., distance D). In another example, as shown in FIGS. 1-2, a pair of actuators 50, such as air cylinders, hydraulic cylinders, linear actuators, or the like can also selectively adjust the gap between the web positioning roller 14 and the glue applicator roll 16 to a relatively large distance, such as about 4 inches, to meet various safety requirements.

During operation of the glue machine, the glue applicator roll 16 rotates and picks-up adhesive from the glue tray 62 onto the smooth peripheral outer surface of the glue applicator roll 16. As the adhesive rotates past the isobar assembly 64, a metering rod removes excess adhesive from the outer surface of the glue applicator roll 16 and leaves a precisely controlled extremely thin layer of adhesive coating 4 on the outer surface of the glue applicator roll 16. As the glue applicator roll 16 continues to rotate, the precisely controlled adhesive coating 4 travels from the isobar assembly 64 to a position adjacent the gap 18; that is, the location where the flutes 7 of the corrugation assembly engage the glue applicator roll 16 as previously described.

The web positioning roller 14 rotates adjacent to the glue applicator roll 16. The rollers 14, 16 can rotate in the same direction, or alternatively in opposite directions. The first face sheet smoothly engages the outer surface of the web positioning roller 14 and is held substantially against slippage relative thereto. As the flutes 7 of the corrugation assembly pass through the nip point of the precisely controlled vertical gap 18 between the glue applicator roll 16 and the web positioning roller 14, the flutes come into contact with the thin coating 4 of adhesive and/or the glue applicator roll 16 as described above.

As the flutes 7 pass through the nip point of the vertical gap 18, the thin coating 4 of adhesive on the glue applicator roll 16 is transferred to the crests of the flutes 7. Any spray of adhesive generated at the nip point is downwardly directed without a horizontal velocity component. Therefore, no adhesive is sprayed outside the glue tray 46, which is located directly below the nip point, even at high speeds. Additionally, gravity reduces or eliminates any pooling problems of the adhesive because gravity pulls the adhesive straight down at the nip point.

Referring to FIG. 4, a more detailed example method for applying adhesive to the crests of the flutes of a corrugated sheet 18 is shown. In this method, the position of the web positioning roller 14 is set to adjust the gap 18 between the web positioning roller 14 and the glue applicator roll 16 so that the flutes are compressed a percentage of their initial flute height upon contact with the glue applicator roll 16. Various degrees of compression can be utilized, such as 3-30, preferably 5-15 or even 5-10, percent of their initial flute height. In other words, the flutes are compressed down to 70-97, preferably 85-95 or 90-95, percent of their initial flute height.

As shown, a characteristic flute 150 has a leading sloped face 151, a trailing sloped face 152, and a crest 153. (Flute 150 in FIG. 4 is simply a characteristic flute 7 as it passes through the gap 18. The reference numeral 150 is used here instead of 7 merely for clarity to indicate a flute as it passes through the gap 18). In FIG. 4, the notation a/b/c refers to the relative position of the characteristic flute 150; i.e. 150a refers to a position prior to contact with the glue applicator roll 16, 150b refers to a position at the nip point in contact with the glue applicator roll 16, and 150c refers to a position following contact with the glue applicator roll 16. This a/b/c notation is used consistently in the following description with reference to FIG. 4. As the flute 150a approaches the glue applicator roll 16, the leading sloped face 151a first contacts the glue applicator roll 16 and has adhesive deposited thereupon. As the flute 150a proceeds into full contact with the applicator roll at 150b, the leading sloped face 151a proceeds to 151b as shown, with glue now having been applied both to the leading sloped face 151b and the crest 153b. As can be seen from the figure, no glue has been applied to the trailing sloped face 152b because as the flute proceeds from 150a to 150b, it is compressed such that the trailing sloped face 152b is generally shielded or isolated from contact with the glue applicator roll 16. Thus, the trailing sloped face 152b generally does not come into contact with any glue.

Moreover, because the passing web 5 is guided by the web positioning roller 14, it has a generally radial contact geometry with the glue applicator roller 16. Thus, a relatively smaller number of flutes 150 is generally in contact with the glue applicator roller 16 as compared to a passing web having a more straight line contact (not shown) with the glue roller. Further, the radial contact geometry permits the glue applicator roller 16 to contact the center of the crest 153b so as to localize the glue deposition. Because neither the leading nor trailing edges 151b, 152b of the flute 150b are generally bonded to an associated face sheet, it can be beneficial to provide the glue generally upon the flute crest 153b. As a result, the width of the glue line deposited on the crest 153b can be better controlled.

Because the corrugation assembly 5 is substantially wrapped around the web positioning roller 14 and/or the size of the rider system is minimized, the flutes 150 contact the glue applicator roll 16 only at the nip point of the gap 18 so that they are wetted with adhesive and compressed at essentially the same time. Preferably, only 1 to 2 flutes 150 are in contact with the adhesive and/or the applicator roll 14 at any given time. No presoaking or post soaking of the flutes 150 occurs; that is, the flutes 150 generally do not touch the adhesive before reaching the nip point 18 or after leaving the nip point 18. Therefore the dwell time, the time for which the flutes 150 are in contact with the adhesive and/or the applicator roll 14, is minimized so that the flutes 150 can remain as resilient as possible.

As shown, the degree of compression is realized by the crest 153b of the flute 150b being “flattened” (or even partially concave) to generally conform to the outer peripheral surface of the glue applicator roller 16. That is, the flute 150b is generally not bent backwards or forwards. Instead, the crest 153b is compressed generally towards the web positioning roller 14. However, because the flute 150b is generally not best backwards or forwards, the crest 153b can become generally enlarged (i.e., widened) so as to present a greater surface area against the glue applicator roller 14. For example, the crest 153b of flute 150b has a relatively larger surface area as compared to the crest 153a of flute 150a that is only partially in contact with the glue applicator roller 14, and even the crest 153 of flute 150 that is not at all in contact with the glue applicator roller 14.

In other words, the degree of compression, coupled with the size of the flutes 150, can control the width of the flute crest 153b that is in contact with the glue applicator roll 16 and the glue contained thereon. As a result, glue line width (i.e., width in the longitudinal direction for each flute 150) can be generally equal to the width of the flattened surface (i.e., of the flute crest 153b) that is compressed against the glue applicator roller 16. As a result, the glue line width can be controlled despite changes in glue line thickness.

As the flute proceeds from 150b to 150c, initially there is glue both on the crest 153b and the leading sloped face 151b. However, it is generally only desired to have glue on the crest and not the leading sloped face. Otherwise, washboarding and directional strength variations in the finished corrugated cardboard product can result as above described. To solve this problem, during operation the applicator roll is rotated at a low speed such that the surface linear velocity of the applicator roll is much lower than the velocity of the corrugated sheet 5 through the gap 18. The surface linear velocity of the glue applicator roll 16 refers to the linear speed of the outer surface of the glue applicator roll 16, measurable in feet per minute (or the like). The surface linear velocity is related to the angular velocity (i.e. rotations per minute or RPMs) by the relation v=2*pi*r*Ω; where v is the surface linear velocity in feet/min, r is the radius of the glue applicator roll 16 in feet, and Ω (Omega) is the angular velocity of the glue applicator roll 16 in RPMs. Preferably, the outer surface linear velocity of the glue applicator roll 16 is less than 95% that of the corrugated sheet, more preferably less than 90, preferably 80, preferably 60, preferably 50, preferably 45, and most preferably 40, percent that of the corrugated sheet 18, though various other percentages can also be used. The above ratio of glue applicator roll 16 speed to corrugated sheet 18 is referred to as the roll speed ratio.

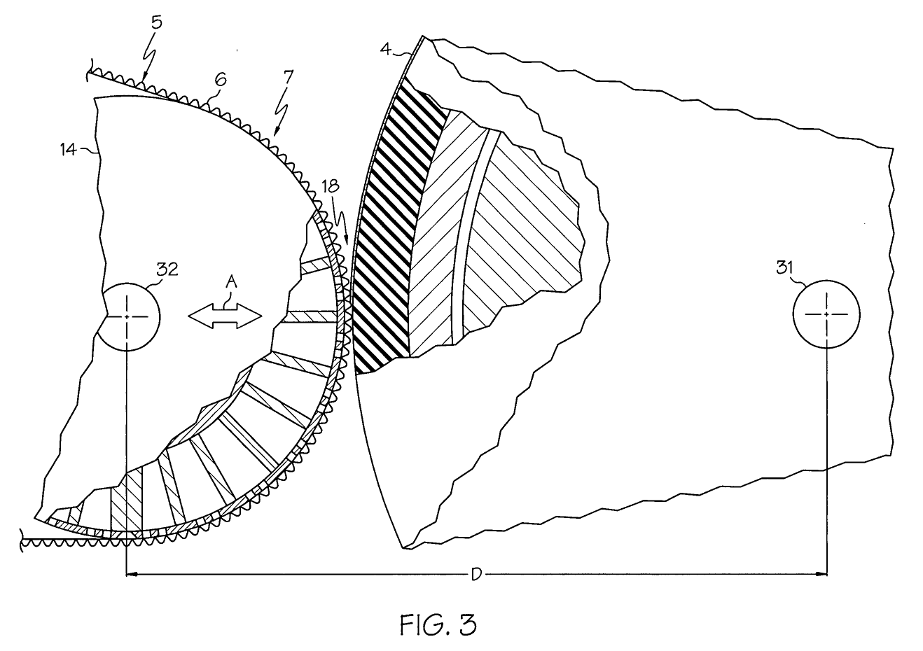

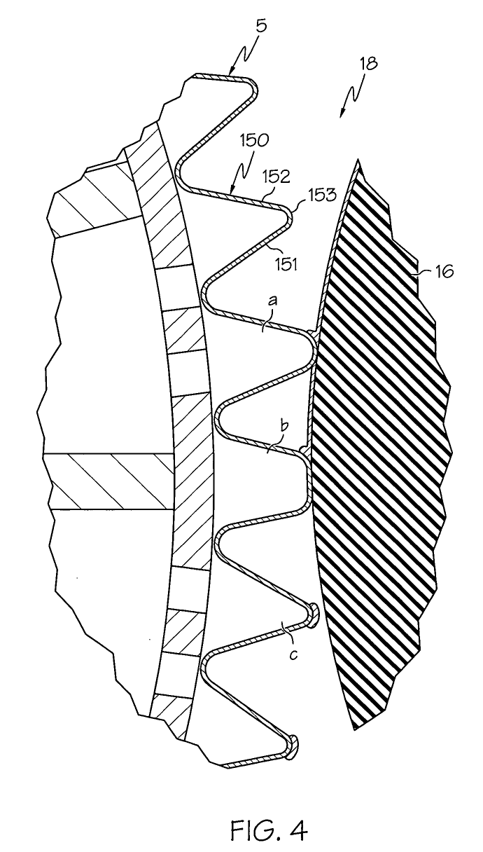

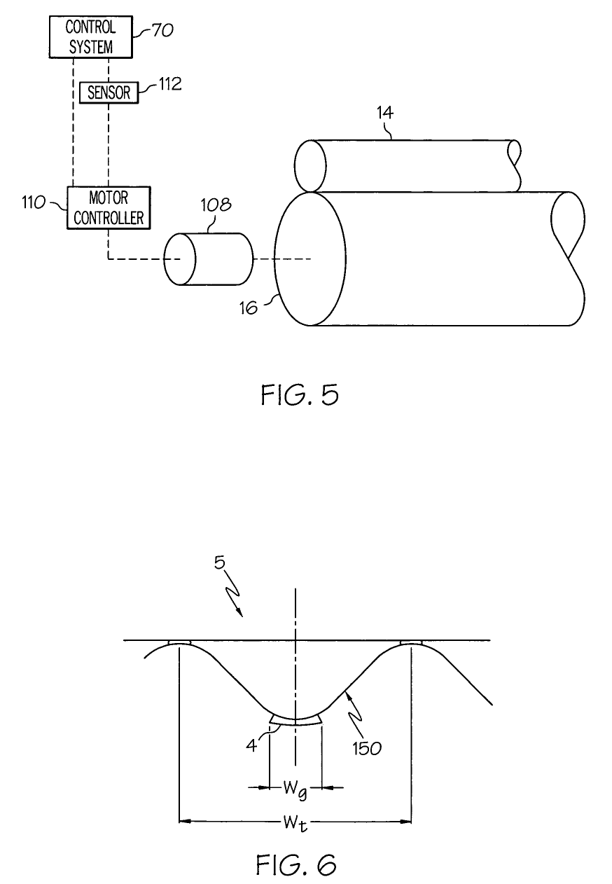

FIG. 5 schematically illustrates an example drive system for the glue applicator roll 16. A variable speed motor 108 can be connected to the glue applicator roll 16 to provide power to rotate the glue applicator roll 16 during the operation of the machine. An electronic motor control 110 is connected to the motor 108 and adjustably controls the rotational speed of the glue applicator roll 16. This ability to control the speed of the roll 16 is an important feature of the present invention because it allows adjustment of the applicator roll surface linear velocity relative to the velocity of the web positioning roller 14 (and therefore corrugated sheet 5) as described above. This provides the very precise control of the transfer of adhesive from the glue applicator roll 16 to the flutes 7 of the corrugated sheet 5. In addition or alternatively, the motor controller 110 can utilize information from a sensor 112 to control the speed of the glue applicator roller 16. The sensor 112 can include a glue weight sensor (e.g., as described in U.S. Pat. No. 6,602,546 incorporated hereinabove), a speed sensor, a flute height sensor, a web width sensor, a web tension sensor, or even various other types of sensors. In addition or alternatively, the motor controller 110 can be at least partially controlled by the closed-loop control system 70, which can also receive input from the sensor 112. In addition or alternatively, is to be understood that the above-described example drive system can similarly be applied for controlling the web positioning roller 14.

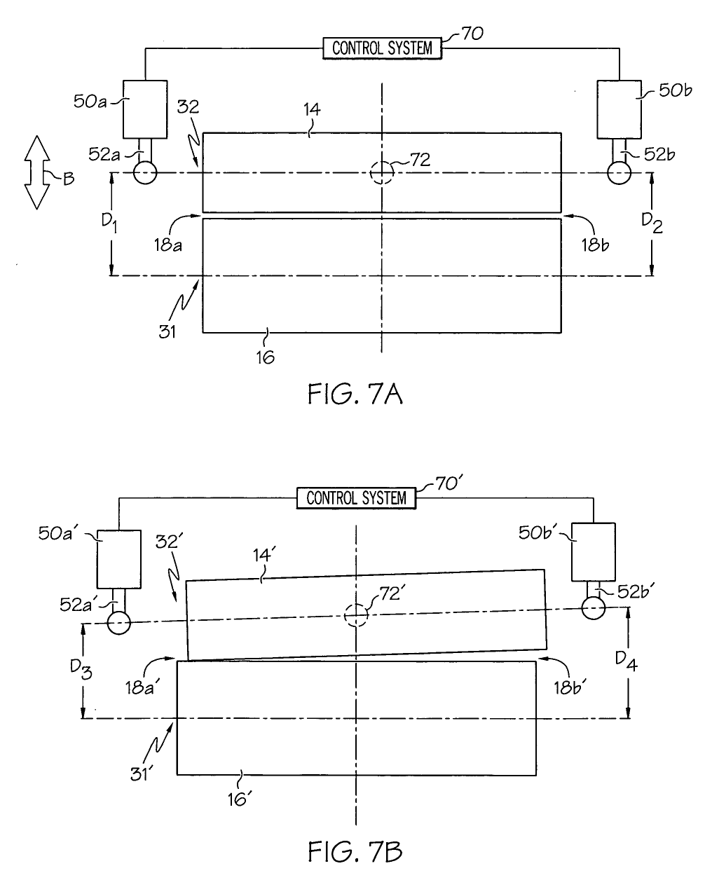

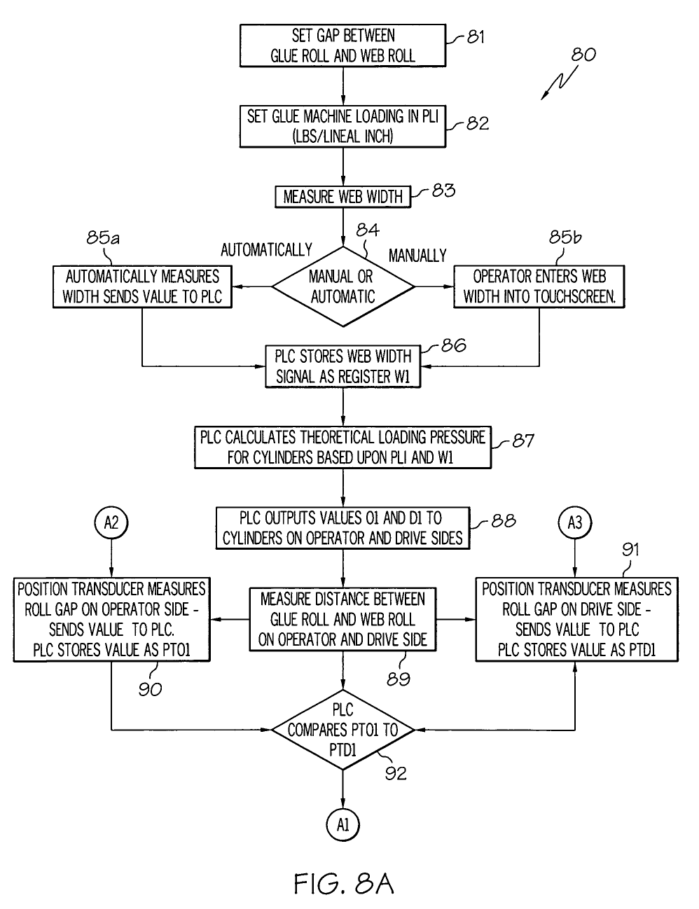

Turning briefly to FIG. 6, various glue line widths can be utilized, and can be defined in absolute terms or, because there are numerous standard flute sizes (i.e., A, B, C, E, F, G, etc.), as a percentage of the total width Wₜ of a single flute 150 (i.e., a percentage of the total width of a single flute 150 of a standard flute size). In one example, it can be beneficial to have the glue line width W_{g} be generally in the range of 15-30% of the total width of a single flute 150. For example, each of the standard flute sizes (i.e., A, B, C, E, F, G, etc.) can have a preferable glue line width W_{g} percentage, such as 15-18%, 16-20%, 15-19%, 19-24%, 21-27%, and 22-30%, respectively. Still, various other percentages can also be utilized. Therefore, adjustments in gap width, pressure loading, and/or a radial contact geometry can provide a relatively more consistent amount, location, thickness, and/or width of glue that can be applied to each flute crest 153.

Additionally, the difference between the linear speeds of the rollers 14, 16 can facilitate “scrubbing” of the glue 4 into the hills and valleys on the flute crest 153b, which can be especially beneficial with relatively smaller flute sizes. In other words, the difference between linear speeds can smear the glue 4 into the hills and valleys on the flute crest 153b to increase wetting and provide an appropriate amount of glue for increased bond strength. Moreover, the pressure at which the flutes 7 are compressed against the roller 16 surface (and the corresponding degree of compression of those flutes 7) can also facilitate the “scrubbing” of the glue 4 into the hills and valleys on the flute crest 153b. However, it can also be beneficial to control the speed differential and/or the pressure applied to the flutes 7 so as to obtain the desired scrubbing action without causing damage to the web 5.

In addition to the relative linear speeds of the rollers 14, 16, various other factors can influence the glue deposition upon the flutes 7. For example, the width of the gap 18 (i.e., as determined by the width D between the rotational axes 31, 32 of the rollers 14,16) and/or the pressure applied between the flutes 7 and the glue applicator roller 16 can also influence the glue deposition.

In one example, as shown in FIGS. 1-2, an actuator 50, which can act as a pressure and/or gap metering controller, can be utilized to control the width of the gap 18 and/or the pressure applied to the flutes 150. The actuator 50 can be coupled to the second support arm 20b, for example, which otherwise is freely adjustable during machine operation as described previously herein. The controller 50 is capable of precisely metering the width of the gap 18 between the positioning and applicator rollers 14 and 16, and/or the pressure exerted by the roller 14 on the flutes against the applicator roller 16 to achieve optimal glue application to the passing flute crests 6. Because of the cross-member 25, the actuator 50 does not have to compensate or account for tension in the web 5, nor is its operation or the precise metering of gap 18 substantially disturbed or affected due to even significant sudden or unpredictable changes in web tension. This presents several significant advantages over conventional glue machines. First, the actuator 50 can incorporate very high precision motors, servos, pneumatic cylinders, or the like, or suitable combinations of these or other conventional mechanical or pneumatic or hydraulic metering devices, to achieve very high precision metering of the position of roller 14 as well as the pressure exerted thereby on the web 5 against the applicator roller 16, to provide precise dynamic gap metering control for a wide range of different flute sizes (e.g., sizes A through E or smaller) to achieve optimal glue-to-flute application. Conventionally, very high precision metering components for the controller 50 were problematic due to relatively large web tension-effect forces, as well as sudden significant changes in such forces, that the controller 50 had to withstand and compensate for. Because these large magnitude forces have been mechanically nulled or compensated out by the cross-member 25, higher precision and more sensitive metering devices can be used in the actuator 50. Optionally, the actuator 50 can be coupled to the first support arm 20a in order to regulate the width of the gap 18, though this is less preferred.

Thus, the roller 14 is permitted to float freely within a predetermined range in an arc about its support pivot joint 22b during operation of the glue machine. Thus, the roller 14 is freely adjustable within this predetermined range during operation of the glue machine. That predetermined range may vary based on the machine and its particular application, but generally will be broad enough to accommodate a wide range of flute sizes, as well as a broad range of compression rates for each flute size that is to be compatible with the glue machine. The predetermined range can be, for example, an arc length of up to at least 1, 2, 3, 4, 5, 6, 7, 8, 9 or 10, inches, with the controller 50 capable to maintain precise dynamic gap metering control within such range.

The glue machine according to the invention allows very precise metering of the gap 18 regardless and independent of the web tension, or of sudden changes in the web tension based on external factors beyond the scope of the glue machine. As described herein, it is important to accurately meter the width of the gap 18 and the pressure exerted by the positioning roller 14 against the flutes 7 (against applicator roller 16) to ensure the correct amount of glue is applied across different flute sizes when such different sizes are used. This is especially important when changing flute sizes in the glue machine.

However, because the glue machine is a dynamic system, it can be beneficial to utilize a control system 70 to maintain a desired gap 18 and/or the pressure exerted against the flutes 7. In addition or alternatively, the control system can be utilized to maintain the rollers 14, 16 parallel to each other to ensure a consistent gap 18 and/or pressure application along the length of the rollers 14, 16.

As previously noted, the gap 18 is preferably precisely closed and opened by the control system 70. Though described herein as a closed-loop control system, an open-loop control system can also be utilized. In one example, the control system 70 can include one or more motors and linear transducer(s) which move the web positioning roller 14 toward and away from the glue applicator roll 16. In another example, as shown in FIGS. 1-2, a pair of the actuators 50, such as air cylinders, hydraulic cylinders, linear actuators, or the like can also selectively adjust the gap between the web positioning roller 14 and the glue applicator roll 16. Still, more than two actuators can also be used.

Side to side accuracy of the precise gap 18, that is along the length of the web positioning roller 14, can be controlled in various manners. In one example, side to side accuracy can be maintained with two adjustment jacks and a cross-connecting shaft. The shaft transversely extends the length of the web positioning roller 14 and the adjustment jacks are located at or near the ends of the shaft so that the web positioning roll outer surface can be adjusted to be parallel to the applicator roll outer surface. It is noted, however, that the cross-connecting shaft could alternately be a central shaft in the web positioning roller 14. Still, because the glue machine is a dynamic system during operation, the rollers 14, 16 can become skewed to varying degrees due to varying web tension, flute height, mechanical tolerances, etc.

In another example, as shown in FIGS. 7A-7B, the control system 70 can selectively and independently adjust either or both of the actuators 50a, 50b, based upon a comparison of a plurality of measurements of the width of the gap 18, to maintain the web positioning roller 14 outer surface to be precisely parallel to the glue applicator roll 16 outer surface. Each of the pair of actuators 50a, 50b has a control arm 52a, 52b coupled (directly or indirectly) to each side of the web positioning roller 14. As a result, independent adjustment of the control arms 52a, 52b along the direction of arrow B can create a virtual pivot point 72 for the web positioning rollers 14 generally about the centerline of the roller 14. Though the control system 70 will be described with reference to making adjustments to the web positioning roller 14, it is to be appreciated that the control system can also be adapted to make adjustments to the applicator roller 16 (e.g., in addition to, or as an alternative to, the roller 14).

For example, as shown in FIG. 7A, the web positioning roller 14 is arranged generally parallel to the applicator roller 16. The rotational axes 31, 32 of the rollers 14, 16 are substantially parallel, such that the distance D1 between the axes 31, 32 on the left-hand side is substantially equal to the distance D2 on the right-hand side. As a result, the width of the gaps 18a, 18b located on each side of the roller 14 are substantially equal, and a web 5 passing therethrough can experience substantially the same gap and/or pressure along the lengths of the rollers 14, 16.

However, turning to FIG. 7B, the rotational axes 31, 32 of the rollers 14, 16 are illustrated skewed with respect to each other. It is to be understood that similar numbers are used for similar elements, and are labeled with a prime (′) designation. As shown, the web positioning roller 14′ is skewed relative to the applicator roller 16 about the virtual pivot point 72′. The distance D3 is less than the distance D4, and as a result the width of gap 18a′ is less than the width of gap 18b′. Thus, a web 5 passing therethrough will experience a relatively smaller gap (and possibly a higher pressure) located along the left-hand side relative to the relatively larger gap (and possibly a lower pressure) located along the right-hand side. As a result, glue line width and/or thickness can undesirably vary, and/or the flutes 7 can become damaged.

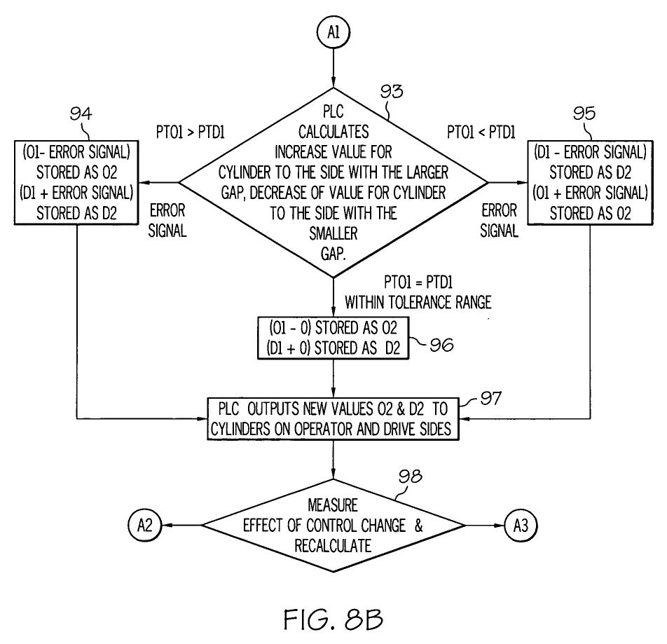

Because the glue machine is a dynamic system during operation, the rotational axes 31, 32 of the rollers 14, 16 can become skewed to varying degrees for various reasons. Thus, the control system 70 can be utilized to automatically maintain each of the rotational axes 31, 32 to be substantially parallel to one another in real time, which will maintain the width of the gaps 18a, 18b located on each side of the roller 14 to be substantially equal. To accomplish this, the control system 70 can employ a control algorithm 80, such as the one illustrated in FIGS. 8A-8B. The control algorithm 80 can be performed by a computer or the like, such as a programmable logic controller (PLC), though the algorithm 80 can also be performed by various other computers, digital, or even analog components. Moreover, some or all of the control algorithm 80 can be performed by digital or analog circuitry. Similarly, inputs provided to the control system 70, such as various inputs to the control algorithm 80, can be provided in digital and/or analog formats. Some or all of the steps of the algorithm 80 can be automated, and/or some of the steps of the algorithm 80 can be provided manually by an operator, such as various input values or the like. Moreover, the control algorithm 80 can include more, less, and/or even different steps than those illustrated herein.

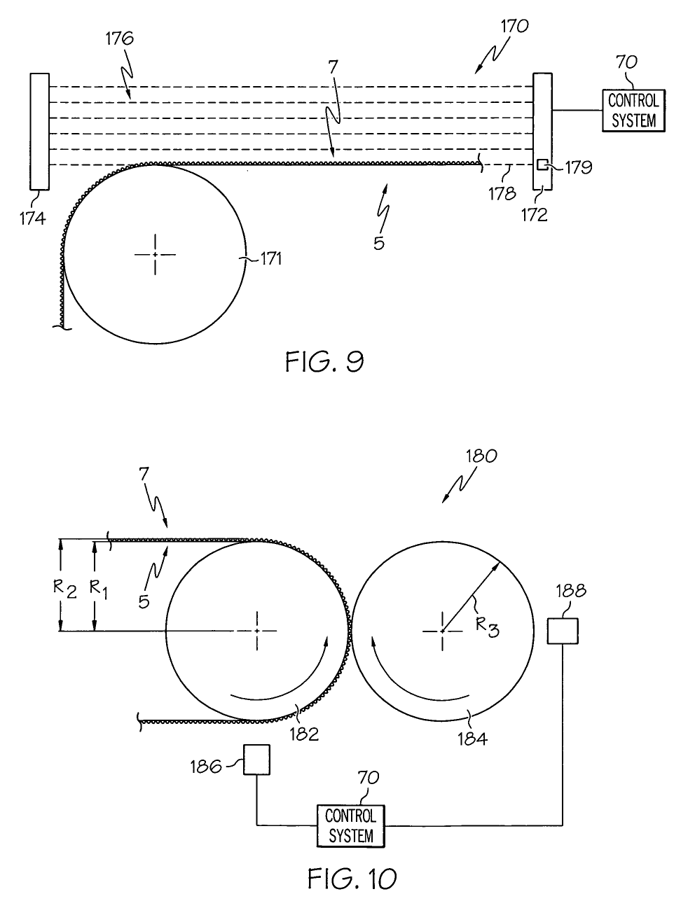

Turning now to FIG. 8A, the control algorithm 80 will be described in further detail. First, in step 81, a desired width of the gap 18 is set between the web positioning roller 14 and the glue applicator roller 16 to thereby regulate a degree of compression of the flutes 7 against the applicator roller 16. The desired width of the gap 18 can be manually input (directly or indirectly), or automatically selected. For example, an operator can manually input a flute size, and the control system 70 can select a desired width of the gap 18 that is associated with each of the standard flute sizes (e.g., sizes A through E or smaller), such as from a discrete set of gap widths or even by calculation of a gap width. In one alternative, an operator can either manually input a gap width directly (i.e., in inches, millimeters, etc.). In another alternative, the control system 70 can include an automatic flute sensor, such as that described more fully herein below in association with FIGS. 9-10, that can automatically determine the standard flute size, and choose a desired gap width. Upon determining the desired gap width, the control system 70 can utilize the actuators 50a, 50b to provide the desired and predetermined gap width between the web positioning roller 14 and the glue roller 16 on each side thereof.

Next, at step 82, a desired glue machine loading is set between the web positioning roller 14 and the glue applicator roller 16. The desired glue machine loading can be determined in terms of pounds per lineal inch (PLI), though various other units can also be used. Generally, the glue machine loading value can be within the range of 1-10 pounds, though various other values can also be used. In other words, the glue machine loading determines the amount of force the actuators 50a, 50b will apply to the flutes 7 against the glue applicator roller 16. It is to be understood that the total force applied to the flutes 7 will be generally equivalent to the sum of the forces provided by each of the actuators 50a, 50b. For example, if each of the actuators 50a, 50b provides 50 pounds of force, the flutes will experience a total force of 100 pounds. Again, the glue machine loading can be manually input (directly or indirectly), or automatically determined by the control system 70.

Next, at step 83, the width of the web 5 is determined. The width of the web 5 refers to be the transverse width of the web 5 (i.e., the dimension oriented transverse to the longitudinal axis of the web 5). As shown in step 84, the width of the web 5 can be automatically determined (step 85a) by the control system 70, or manually input (step 85b, directly or indirectly). An automatic web width sensor can be a contact or non-contact design, such as a mechanical feeler, a light curtain or the like for measuring the width, etc. Upon determining the web width, the algorithm 80 proceeds in step 86 to store the width value, such as in a variable W₁.

Next, at step 87, the loading pressure for the actuators 50a, 50b is calculated. The loading pressure is based upon the glue machine loading and the web width. As described above, the glue machine loading can be provided in units of pounds per lineal inch, while the web width can be provided in units of lineal inch. Thus, upon multiplying these two values together, the loading pressure can be provided in units of pounds (force). For example, where the glue machine loading is 2 pounds per lineal inch, and the web width is determined to be 50 inches, then the loading pressure is calculated to be 100 pounds force (i.e., 2×50=100). As a result, the sum of the forces provided by the actuators 50a, 50b would be 100 pounds force. Generally, each of the actuators may provide approximately half of the loading pressure (i.e., 50 pounds each), though the actual amount provided by each of the actuators 50a, 50b may vary and/or be unequal during operation. Moreover, in step 88, the algorithm 80 can calculate and transmit the appropriate signals or values O1 and D1 for each of the actuators 50a, 50b, respectively, to directly or indirectly obtain the desired loading pressure.

Next, in step 89, the distances between the web positioning roller 14 and the glue applicator roller 16 are measured on each side (i.e., 18a and 18b of FIG. 7A) of the rollers 14, 16. For example, in step 90, a first actual width of the gap 18a between the first end of the web roller 14 and the glue roller 16 is measured. The first actual width is stored by the algorithm 80 as value PTO1. Similarly, in step 91, a second actual width of the gap 18b between the second end of the web roller 14 and the glue roller 16 is measured. The second actual width is stored by the algorithm 80 as value PTD1. It is to be understood that the first and second actual widths can be measured in various manners. In one example, the actual gap widths can be measured via a sensor, such as a position transducer, coupled to or incorporated into each of the actuators 50a, 50b. In another example, the actual gap widths can be measured via a sensor that measures the distance (e.g., distances D1-D4 of FIGS. 7A-7B) between the rotational axes 31, 32 of the rollers 14, 16 and calculates the gaps 18a, 18b. In yet other example, the actual gap widths can be directly measured between the rollers 14, 16, such as through various contact or non-contact mechanical, electronic, or optical means. Various examples can include mechanical feelers, photodetectors, lasers, radar and/or ultrasonic sensors or the like.

Next, in step 92, the actual gap widths PTO1 and PTD1 are compared against each other. In one example, the algorithm 80 can merely determine which of the values is greater than the other, while in another example, the algorithm 80 can determine a percentage difference. In another example, the algorithm 80 can calculate a difference distance between the actual gap widths PTO1 and PTD1 (i.e., PTO1−PTD1). Next, in step 93, the algorithm 80 can determine how to independently operate the actuators 50a, 50b to reduce the difference between the actual gap widths. Generally, at step 93, the algorithm 80 will increase the length of the control arm 52a, 52b associated with the relatively larger actual gap width, while maintaining or even decreasing the length of the control arm 52a, 52b associated with the relatively smaller actual gap width. Though length adjustment to both of the control arms 52a, 52b have been discussed, it is to be understood that corrections can be applied to only one of the control arms 52a, 52b while the other remains stationary.

For example, where the actual gap width PTO1 is determined to be larger than PTD1, the algorithm 80 will proceed to step 94. The algorithm 80 will calculate new values for each of the actuators 50a, 50b. For example, because the gap width PTO1 is determined to be larger than PTD1, the algorithm 80 can subtract a value, such as an error signal, from the original signal O1 provided to the actuator 50a in step 88 to provide an adjustment distance therefor. Similarly, the algorithm 80 can add a value, such as the error signal, to the original signal D1 provided to the actuator 50b in step 88 to similarly provide an adjustment distance therefor. In other words, because the gap width PTO1 is larger, the control arm 52a of the associated actuator 50a is extended an adjustment distance, while the control arm 52b of the associated actuator 50b is retracted an adjustment distance. Various error signals can be used to generate various adjustment distances. In the shown example, because the virtual pivot point 72 is located generally about the center of the web positioning roller 14, the error signal can be equal to one-half of the difference between the actual gap widths PTO1 and PTD1. Still, the error signals can be different, non-equal, etc.

The algorithm can then store the new calculated actuator signals (e.g., adjustment distances) as values O2 and D2. Next, in step 97, the algorithm 80 can transmit the appropriate corrected signals or values O2 and D2 for each of the actuators 50a, 50b, respectively, to directly or indirectly obtain the corrected loading pressure for adjustment of the control arms 52a, 52b to offset the skewed alignment between the rollers 14, 16. It is to be understood that while the loading pressures for each of the actuators 50a, 50b may increase or decrease, and/or may be un-equal, the sum of the forces provided by the actuators 50a, 50b would remain as previously calculated in step 87 (e.g., 100 pounds force in the described example).

Next, in step 98, the algorithm 80 will proceed to measure and determine the effect of the changes applied to the actuators 50a, 50b. As shown, the algorithm 80 will loop back to steps 90 and 91 to re-measure the actual gap widths 18a, 18b as described previously herein. The algorithm 80 will then proceed through steps 92-98 to make further corrections. It is to be understood that the algorithm 80 can repetitively proceed through steps 89-98 in an iterative fashion until the actual measured gap widths PTO1 and PTD1 are substantially equal. Still, even where the measured gap widths are substantially equal, the algorithm 80 can still continue to perform steps 89-98 iteratively during operation of the glue machine 10 because of the dynamic nature of its operation.

In addition or alternatively, the control system 70 can utilize threshold values to reduce, such as prevent, correction of de minimis differences between the actual gap widths 18a, 18b. For example, the sensors for measuring the actual gap widths 18a, 18b can have a resolution, such as 32,000 units or counts. Each unit or count can correspond to a known value, such as 0.001 inches or the like. The control algorithm 80 can be selectively set to ignore de minimis differences between the actual gap widths 18a, 18b based upon a threshold number of units. For example, the threshold can be 10 units or counts, though various other threshold values can be programmed into the algorithm 80. In other words, the control algorithm 80 can ignore any de minimis difference between the actual, measured gap widths PTO1 and PTD1 that is less than 10 units of sensor resolution.

Turning briefly back to step 95, it is to be understood that this step operates similarly and alternatively to that of previously described step 94 to calculate new values for each of the actuators 50a, 50b. That is, where the gap width PTO1 is determined to be less than PTD1 (e.g., see FIG. 7B), the algorithm 80 can add a value, such as an error signal, to the original signal O1 to provide an adjustment distance therefor. Similarly, the algorithm 80 can substract a value, such as the error signal, from the original signal D1 to similarly provide an adjustment distance therefor. In other words, because the gap width PTO1 is smaller, the control arm 52a of the associated actuator 50a is retracted an adjustment distance, while the control arm 52b of the associated actuator 50b is extended an adjustment distance. The algorithm can then store the new calculated actuator signals (e.g., adjustment distances) as values O2 and D2, and in step 97, can transmit the appropriate corrected signals or values O2 and D2 for each of the actuators 50a, 50b. The algorithm 80 can then proceed to step 98 to loop back to step 89 to repeat the process, as described previously herein.

Similarly, turning briefly back to step 96, it is to be understood that this step operates similarly and alternatively to both of previously described steps 94 and 95 to calculate new values for each of the actuators 50a, 50b. That is, where the gap width PTO1 is determined to be substantially equal to PTD1 (e.g., see FIG. 7A), or even within the previously described sensor resolution threshold, the algorithm 80 can maintain the values for each of the control arms 52a, 52b. The algorithm 80 can pass, such as copy, the values O1 and D1 to provide the new values O2 and D2. Alternatively, if desired, the algorithm 80 can add a value, such as zero, to each of the original signals O1 and D1 to provide the new values O2 and D2. The algorithm 80 can then proceed to step 98 to loop back to step 89 to repeat the process, as described previously herein.

It is to be understood that in addition to maintaining the rollers 14, 16 parallel to each other, the control system 70 can also be utilized to ensure a consistent gap 18 along the length of the rollers 14, 16. For example, as previously described, the algorithm 80 can similarly begin at step 81 to determine a desired width of the gap 18. The gap 18 can be manually or automatically selected, and can be directly input in absolute terms (i.e., in inches or millimeters), or can be selected from a discrete set of width values that are each associated with the standard flute sizes (e.g., sizes A through E or smaller). Next, the algorithm 80 can proceed through steps 82-88 as described above to move the web positioning roller 14 to set the initial, desired gap width. The algorithm 80 may further include a step of verifying, either manually or automatically, the actual gap distance. Next, the algorithm 80 can them proceed repetitively and iteratively through steps 89-98 to automatically adjust the position of the web positioning roller 14 relative to the glue applicator roller 14, via adjustments of the control arms 52a, 52b, to maintain the preselected and desired width of the gap 18 along the lengths of the rollers 14, 16. In other words, once the initial gap 18 is set, the algorithm 80 can maintain the preselected width along the lengths of the rollers 14, 16 via constant comparison of the measured actual gap widths PTO1 and PTD1 and selective adjustment thereof. Still, more or less various other measurements can also be utilized.

In addition or alternatively, the control system 70 can also be utilized to ensure a consistent pressure application along the length of the rollers 14, 16. For example, as previously described, the algorithm 80 can similarly begin at step 81 to determine a desired width of the gap 18 via manual or automatic means. Next, the algorithm 80 can proceed through steps 82-88 as described above to move the web positioning roller 14 to set the initial, desired gap width, and also the desired loading pressure. The algorithm 80 may further include a step of verifying, either manually or automatically, the actual gap width and/or the loading pressure applied. Next, the algorithm 80 can them proceed repetitively and iteratively through steps 89-98 to automatically adjust the position of the web positioning roller 14 relative to the glue applicator roller 14, via adjustments of the control arms 52a, 52b, to maintain the preselected and desired loading pressure along the lengths of the rollers 14, 16. In other words, once the initial loading pressure is set, the algorithm 80 can maintain the preselected pressure along the lengths of the rollers 14, 16 via constant comparison of the measured actual gap widths PTO1 and PTD1 and selective adjustment thereof. Still, the algorithm 80 can include various additional steps to measure, verify, and/or adjust the actual pressure applied along the lengths of the rollers 14, 16 via adjustment of the control arms 52a, 52b. For example, the algorithm 80 can include a set of steps similar to those of steps 89-98 that are performed repetitively and iteratively to compare the actual pressure applied by each of the actuators 50a, 50b, and to adjust the pressures thereof until the difference between the actual pressures is substantially zero (or even within the previously described sensor resolution threshold). Still, the total force applied to the flutes 7, will be generally equivalent to the sum of the forces provided by each of the actuators 50a, 50b via the loading pressures thereof.

In addition or alternatively, as indicated in the above description, the desired width of the gap 18 can be automatically determined in step 81 for use in some or all of steps 82-88. Thus, the control system 70 can include an automatic flute sensor that can automatically determine the flute size. Where the flute size corresponds to a standard flute size (e.g., sizes A through E or smaller), the algorithm 80 can determine a desired gap width from among a discrete set of predetermined and associated gap widths. Alternatively, even if the flute size corresponds to a standard flute size, the algorithm 80 can determine, such as calculate, a desired gap width based upon the actual measured flute size. In either event, the algorithm 80 can determine a desired gap width based upon the measurement of a single flute, or even a plurality of flutes. In one example, the algorithm 80 can determine an average flute height based upon a measurement of a plurality of flute heights. In another example, the algorithm 80 can determine the flute height based upon a minimum, maximum, median, or mode value of a plurality of flute heights.

The automatic flute height sensor can be a non-contact design, such as a light curtain or the like (see FIG. 9), or a contact design, such as parallel rollers (see FIG. 10), for measuring the flute height. Upon determining the flute height and then the desired gap width, the control system 70 can utilize the actuators 50a, 50b to provide the desired and predetermined gap width between the web positioning roller 14 and the glue roller 16 on each side thereof. Though the automatic flute height sensor can be located variously about the glue machine 10 (or even at various other locations in the corrugation manufacturing process), it can be beneficial to locate the automatic flute height sensor upsteam of the glue applicator roller 16 to permit advance adjustment of the gap width.

Turning now to FIG. 9, one example of a non-contact automatic flute height sensor 170 is described. A portion of the corrugated web 5, including flutes 7 having a flute height, is driven though the non-contact automatic flute sensor 170 by an idler roller 171 or the like. As shown, the non-contact automatic sensor 170 can be a light curtain or the like that includes a pair of light towers 172, 174 separated by a distance for optically measuring the average height of the flute crests.

A photoelectric transmitter is contained within either or both of the light towers 172, 174 and projects an array of synchronized, parallel infrared light beams 176 to a receiver unit (i.e., the other of the light towers 172, 174). When an opaque object, such as the tips of the flutes 7, interrupts one or more of the light beams 176, such as beam 178, control logic of the light curtain sends a signal to the control system 70. In one example, the photoelectric transmitter unit can contain light emitting diodes (LEDs) that emit pulses of visible light, or invisible infrared or ultraviolet light, when energized by the light curtain's timing and logic circuitry. The light pulses can be sequenced (i.e., one LED is energized after another), and/or modulated (i.e., pulsed at a specific frequency). For example, corresponding photo-transistors and supporting circuitry in the receiving unit can be designed to detect only the specific pulse and frequency designated for it to offer enhanced usability and/or rejection of external light sources. The control logic, user controls and diagnostic indicators may be self-contained, or even a portion of the control system 70.

Thus, by determining which of the light beams 176 in the array were interrupted by the passing flutes 7, the control system 70 can determine the height of the flutes 7. Similarly, if the passing flutes 7 interrupt multiple, different light beams 176, the control system 70 can determine an average flute height based upon which light beams 176 were interrupted. Moreover, it is to be understood that the resolution of the light curtain, that is, the number and/or density of light beams 176 available for interaction with the flutes 7, can vary and can determine the accuracy of the non-contact automatic flute height sensor 170.

In another example, the photoelectric transmitter unit can contain lasers that emit pulses of visible or invisible light when energized by the light curtain's timing and logic circuitry. The light pulses can be sequenced (i.e., one laser is energized after another), and/or modulated (i.e., pulsed at a specific frequency), and can otherwise operate as discussed above. In yet other examples, the non-contact automatic flute height sensor 170 can utilize radar or ultrasonic sensors or the like.

In addition or alternatively, the non-contact automatic flute height sensor 170 can utilize one or more movable sensors. For example, either or both of the light towers 172, 174 can include a movable light sensor 179 that is vertically movable with respect to the light towers 172, 174. The movable light sensor 179 can utilize LEDs, lasers, or the like as described above. The receiving light tower 174 can include a plurality of receiving sensors or photodetectors, or can even include a matching vertically movable sensor that moves in unison with the sensor 179. In one example operation, the movable light sensor 179 can emit a light beam (similar to light beams 176) while it vertically descends in a downwardly fashion until the light beam is interrupted by a passing flute 7. As a result, the height of the flutes 7 can be inferred from the vertical position of the movable sensor 179, or even the particular receiving sensor or photodector to last receive a signal.

Turning now to FIG. 10, one example of a contact automatic flute height sensor 180 is described to mechanically measure the average flute height. A portion of the corrugated web 5, including flutes 7 having a flute height, are driven though the contact automatic flute sensor 180 by a first roller 182 or the like. As shown, the contact automatic flute sensor 180 can be pair of counter-rotating rollers 182, 184 that measure the difference in instantaneous linear speeds to determine the average height of the flute crests.

The first roller 182 is rotated in a first direction at a fixed angular velocity and carries the web therewith. The two rollers 182, 184 are located sufficiently close together such that a portion of the flutes contact the second roller 184 (i.e., an idler roller) and cause it to rotate (e.g., similar to two mated spur gears). The second roller 184 rotates in the opposite direction at generally the same angular velocity. The second roller 184 may include corrugation or other surface features or geometry to facilitate rotation by the passing flutes 7, or may be sufficiently close to the first roller 182 such that frictional drag of the passing flutes 7 causes rotation.

The rollers 182, 184 can have various radii. However, for simplicity, each of the rollers 182, 184 in this example can have the same radius, R₁ and R₃, respectively. A portion of the corrugated web 5, including flutes 7 having a flute height, is driven by rotation of the first roller 182. Thus, the effective outer radius R₂ of the first roller is equal to the sum of the radius of the roller and the flute height (i.e., R₁+the flute height).

Next, the instantaneous linear speeds (ILS) of the first and second rollers 182, 184 are measured by suitable speed sensors 186, 188 and the data transmitted to the control system 70. The instantaneous linear speed of the first roller 182 is measured about a portion that includes the passing flutes 7 (i.e., about a portion defined by R₂). The control system 70 can then determine the average flute height based upon a comparison of the measured instantaneous linear speeds ILS₁, ILS₂ of the rollers 182, 184, respectively.

For example, the instantaneous linear speed of the first roller 182 can be calculated as the circumference (2*pi*effective radius) multiplied by the angular velocity (RPM₁). The effective radius, as described above, is equal to the sum of the known radius of the first roller 182 and the unknown flute height (i.e., R₁ plus the flute height). Thus, the instantaneous linear speed ILS₁ of the first roller 182 can be expressed as (2*pi*(R₁+flute height))*RPM₁. Similarly, the instantaneous linear speed ILS₂ of the second roller can be calculated as the circumference (2*pi*radius R₃) multiplied by the same known angular velocity, RPM₁. In other words, the two resultant equations can be re-written to be RPM₁=(ILS₁/(2*pi*(R₁+flute height)) and RPM₁=(ILS₂/(2*pi*R₃).

As a result, the common variables (2*pi) can cancel out and the only unknown between the two equations is the flute height. Therefore, the flute height can be determined by cross-multiplying the two equations to arrive at the final equation of (ILS₁/(ILS₂)=((R₁+flute height)/(R₃)), from which the flute height can be easily calculated. Moreover, to obtain an average flute height, multiple samples of each of the instantaneous linear speeds ILS₁, ILS₂ can be measured and multiple flute heights calculated and averaged out.

Still, various other contact automatic flute height sensors can be used. For example, an arm (not shown) can ride upon the flute crests and displacement of the arm (i.e., vertical or angular displacement) can be measured as the flute pass thereby to determine the flute height. The arm can be resiliently displaced against the flutes, or can be held by gravity.

It is to be noted that precise gap metering control has been described above with respect to adjusting the position of the web positioning roller 14. Alternatively, it is contemplated that gap metering control can be achieved by fixing the position of the positioning roller 14 and adjusting the position of the glue roller 16. This construction, however, is less preferred because of the relative complexity associated with adjusting the position of the glue applicator roller 16 during machine operation. For example, the thickness of the glue film 4 applied to the circumferential surface of the applicator roller 16 also typically is precisely metered to achieve optimal glue application, e.g., by the methods described in U.S. Pat. No. 6,602,546 incorporated hereinabove. Thus, in order to adjust the relative position of the applicator roller 16, the relative positions of a substantial number of additional machine components also would need to be correspondingly adjusted, such as the glue tray and isobar assemblies described in that patent. For example, one method would be to incorporate all of the applicator roller-associated components onto a subassembly and to provide a rail system for translating the subassembly relative to the positioning roller 14. However, adjustment in this manner may compromise the precision of the glue film application components, as well as contribute excessive complexity and cost to the machine's manufacture. For at least these reasons, it is preferred to adjust the position of the positioning roller 14 relative to that of the applicator roller 16 whose position is fixed on a stationary rotational axis, and to mechanically cancel out web tension-induced forces acting on the positioning roller, or on any of its associated linkages, by incorporating a web tension nulling mechanism as disclosed herein.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A method of applying adhesive to flutes of a corrugated sheet, each said flute having a crest, said method comprising the steps of:
a) applying a layer of adhesive on an outer surface of an applicator roll and rotating said applicator roll;
b) rotating a web positioning roll adjacent said applicator roll, said web positioning roll and said applicator roll each having a rotational axis and defining a gap between respective outer surfaces thereof;
c) moving said corrugated sheet, via rotation of the web positioning roll, along a path adjacent said outer surface of said applicator roll to apply adhesive to said flutes from said layer of adhesive, said path of said corrugated sheet proceeding through said gap;
d) utilizing a control system to automatically maintain each of said rotational axes substantially parallel to one another based upon a comparison of a plurality of measurements of the width of the gap; and
e) contacting said crest of said flute with said applicator roll thereby depositing glue on said crest.

2. The method of claim 1, further including the step of adjusting said position of said web positioning roll relative to said applicator roll to set a predetermined width of said gap and thereby to regulate a degree of compression of said flutes against said applicator roll.

3. The method of claim 2, further including the steps of:
providing the control system with at least a pair of actuators, a first of the actuators being coupled to a first end of the web positioning roll and a second of the actuators being coupled to a second end of the web positioning roll;
utilizing the first actuator to adjust a position of the first end of the web positioning roll relative to the applicator roll; and
utilizing the second actuator to adjust a position of the second end of the web positioning roll relative to the applicator roll, wherein each of the positions of the first and second ends of the web positioning roll are independently adjustable relative to the applicator roll.

4. The method of claim 3, further including the steps of:
utilizing the first actuator to provide the predetermined width of said gap between the first end and the applicator roll; and
utilizing the second actuator to provide the predetermined width of said gap between the second end and the applicator roll.

5. The method of claim 4, further including the steps of:
measuring a first actual width of said gap between the first end of the web positioning roll and the applicator roll;
measuring a second actual width of said gap between the second end of the web positioning roll and the applicator roll; and
utilizing the control system to calculate a difference distance between the first and second actual widths.

6. The method of claim 5, further including the step of utilizing at least one of the first and second actuators to selectively adjust the position of an associated one of the first and second ends of the web positioning roll, relative to the other of the first and second ends of the web positioning roll, an adjustment distance that is based upon the difference distance.

7. The method of claim 1, further including the steps of:
f) measuring a first actual width of said gap between the first end of the web positioning roll and the applicator roll;
g) measuring a second actual width of said gap between the second end of the web positioning roll and the applicator roll;
h) utilizing the control system to calculate a difference distance between the first and second actual widths; and
i) utilizing at least one of the first and second actuators to selectively adjust the position of one of the first and second ends of the web positioning roll, relative to the other of the first and second ends of the web positioning roll, an adjustment distance that is based upon the difference distance; and
j) repeating steps (g), (h), (i), and (j) in an iterative fashion until the difference distance between the first and second actual widths is substantially zero.

8. The method of claim 3, further including the steps of:
determining a desired pressure to be applied to the flute crests passing through said gap based upon the average height; and
adjusting said position of said web positioning roll relative to said applicator roll to set the desired pressure.

9. The method of claim 1, further including the steps of:
measuring an average height of a plurality of the flute crests;
determining a desired width of said gap based upon the average height; and
utilizing the control system to automatically adjust said position of said web positioning roll relative to said applicator roll to maintain the desired width of said gap.

10. The method of claim 1, further including the step of rotating said applicator roll in a first direction and rotating said web positioning roll in a second direction opposite said first direction of said applicator roll.

11. A method of applying adhesive to flutes of a corrugated sheet, each said flute having a crest, said method comprising the steps of:
a) applying a layer of adhesive on an outer surface of an applicator roll and rotating said applicator roll;
b) rotating a web positioning roll adjacent said applicator roll, said web positioning roll and said applicator roll defining a gap between respective outer surfaces thereof;
c) moving said corrugated sheet, via rotation of the web positioning roll, along a path adjacent said outer surface of said applicator roll to apply adhesive to said flutes from said layer of adhesive, said path of said corrugated sheet proceeding through said gap;
d) measuring an average height of a plurality of the flute crests;
e) determining a desired width of said gap based upon the average height;
f) utilizing a control system to automatically adjust said position of said web positioning roll relative to said applicator roll to maintain the desired width of said gap; and
g) contacting said crest of said flute with said applicator roll thereby depositing glue on said crest.

12. The method of claim 11, further including the step of optically measuring the average height of the plurality of flute crests.

13. The method of claim 12, further including the step of utilizing a laser sensor to measure the average height of the plurality of flute crests.

14. The method of claim 11, further including the step of mechanically measuring the average height of the plurality of flute crests.

15. The method of claim 14, further including the steps of:
rotating the web positioning roll to cause movement of the flutes of said corrugated sheet;
positioning an idler roll in a position adjacent said web positioning roll such that the movement of the flutes induces the idler roll to rotate in an opposite direction,
determining a surface linear velocity of the idler roll; and
measuring the average height of the plurality of flute crests based upon the surface linear velocity of the idler roll.

16. The method of claim 11, further including the step of selecting the desired width of said gap from a discrete set of predetermined widths.

17. The method of claim 11, further including the steps of:
determining a desired pressure to be applied to the flute crests passing through said gap based upon the average height; and
utilizing the control system to automatically adjust said position of said web positioning roll relative to said applicator roll to maintain the desired pressure.

18. The method of claim 11, further including the step of utilizing the control system to automatically maintain a rotational axis of the web positioning roll substantially parallel to a rotational axis of the applicator roll.

19. The method of claim 11, further including the step of rotating said applicator roll in a first direction and rotating said web positioning roll in a second direction opposite said first direction of said applicator roll.

20. A method of applying adhesive to flutes of a corrugated sheet, each said flute having a crest, said method comprising the steps of:
a) applying a layer of adhesive on an outer surface of an applicator roll and rotating said applicator roll;
b) rotating a web positioning roll adjacent said applicator roll, said web positioning roll and said applicator roll defining a gap between respective outer surfaces thereof;
c) moving said corrugated sheet, via rotation of the web positioning roll, along a path adjacent said outer surface of said applicator roll to apply adhesive to said flutes from said layer of adhesive, said path of said corrugated sheet proceeding through said gap;
d) measuring an average height of a plurality of the flute crests;
e) determining a desired pressure to be applied to the flute crests passing through said gap based upon the average height;
f) utilizing a control system to automatically adjust said position of said web positioning roll relative to said applicator roll to maintain the desired pressure; and
g) contacting said crest of said flute with said applicator roll thereby depositing glue on said crest.

21. The method of claim 20, further including the step of optically measuring the average height of the plurality of flute crests.

22. The method of claim 21, further including the step of utilizing a laser sensor to measure the average height of the plurality of flute crests.

23. The method of claim 20, further including the step of mechanically measuring the average height of the plurality of flute crests.

24. The method of claim 23, further including the steps of:
rotating the web positioning roll to cause movement of the flutes of said corrugated sheet;
positioning an idler roll in a position adjacent said web positioning roll such that the movement of the flutes induces the idler roll to rotate in an opposite direction,
determining a surface linear velocity of the idler roll; and
measuring the average height of the plurality of flute crests based upon the surface linear velocity of the idler roll.

25. The method of claim 20, further including the step of selecting the desired pressure of said gap from a discrete set of predetermined pressures.

26. The method of claim 20, further including the steps of:
determining a desired width of said gap based upon the average height;
utilizing the control system to automatically adjust said position of said web positioning roll relative to said applicator roll to maintain the desired width of said gap.

27. The method of claim 20, further including the step of utilizing the control system to automatically maintain a rotational axis of the web positioning roll substantially parallel to a rotational axis of the applicator roll.
